(19) United States
(12) Patent Application Publication
(10) Pub. No.: US 2020/0210773 A1
(43) Pub. Date: Jul. 2, 2020

(54) NEURAL NETWORK FOR IMAGE MULTI-LABEL IDENTIFICATION, RELATED METHOD, MEDIUM AND DEVICE

(71) Applicant: BOE TECHNOLOGY GROUP CO., LTD., Beijing (CN)

(72) Inventors: Yue LI, Beijing (CN); Tingting WANG, Beijing (CN)

(21) Appl. No.: 16/551,278

(22) Filed: Aug. 26, 2019

(30) Foreign Application Priority Data
Jan. 2, 2019 (CN) 201910001328.8

(51) Int. Cl. G06K 9/62; G06N 3/04

(52) U.S. Cl. CPC G06K 9/6257; G06N 3/0472; G06K 9/6262

(57) ABSTRACT

A neural network includes: a convolutional network; a multi-feature-layer merging network configured to merge feature maps output by a high-order convolutional layer and a low-order convolutional layer; a spatial regularization network configured to receive the merged feature map; a first content label full connection layer configured to receive a feature map and output a first prediction probability of a content label; a second content label full connection layer configured to receive an N-th order feature map and output a second prediction probability of the content label, the first prediction probability and the second prediction probability of the content label are summed and averaged to obtain a prediction probability; a theme label full connection layer configured to receive the N-th order feature map and output a prediction probability; and a category label full connection layer configured to output a prediction probability of a category label, where 1<n≤N.

### CROSS-REFERENCE TO RELATED APPLICATIONS

The present application claims priority to Chinese Patent Application No. 201910001328.8 filed Jan. 2, 2019, where the entire contents of which are incorporated herein by reference.

### TECHNICAL FIELD

The present disclosure relates to the field of image processing technology, and in particular, to a neural network for image multi-label identification, a method for training the neural network, a method for multi-label identification with the neural network, a storage medium, and a computer device.

### BACKGROUND

The neural network is one of the most important breakthroughs in the field of artificial intelligence in the past decade. It has achieved great success in speech identification, natural language processing, computer vision, image and video analysis, multimedia, and many other fields. On the ImageNet dataset, ResNet's top-5 error is only 3.75%, which is greatly improved compared to a traditional identification method. The convolutional neural network has powerful learning ability and efficient feature expression ability, and has achieved good results in single-label identification.

The labels of the images can be classified into single labels and multiple labels. The former is a single label. That is, each picture only corresponds to one category, such as the category label of the image (Chinese paintings, oil paintings, sketches, gouache paintings, watercolor paintings, etc.), and the category label is judgement and classification of the characteristics of the whole piece of image, which tends to differentiate images as a whole. The latter is multiple labels. That is, each picture corresponds to multiple labels, such as content labels (sky, house, mountain, water, horse, etc.), theme labels, and the like. The content label and the theme label focus on local features of a picture, and are mostly based on the attention mechanism, with label identification performed according to local key features and the position information, which is suitable for identification by comparing local features of two similar themes to determine labels.

However, there is a need for a method of improving the label identification effect.

It is to be noted that the above information disclosed in this Background section is only for enhancement of understanding of the background of the present disclosure, and therefore, it may contain information that does not form the prior art that is already known to a person of ordinary skill in the art.

### SUMMARY

It is an object of the present disclosure to provide a neural network for image multi-label identification and a related method, a medium, and a device.

The present disclosure adopts the following technical solutions.

A first aspect of the present disclosure provides a neural network for image multi-label identification, including:

a convolutional network including N orders of convolutional layers, wherein the first order convolutional layer receives a picture of an image and outputs a first order feature map, and the n-th order convolutional layer receives the (n−1)-th order feature map output by the (n−1)-th convolutional layer and outputs the n-th order feature map;

a multi-feature-layer merging network configured to merge feature maps output by at least one high-order convolutional layer and at least one low-order convolutional layer and output the merged feature map;

a spatial regularization network configured to receive the merged feature map;

a first content label full connection layer configured to receive a feature map output by the spatial regularization network and output a first prediction probability of a content label;

a second content label full connection layer configured to receive an N-th order feature map output by the N-th order convolutional layer and output a second prediction probability of the content label, wherein the first prediction probability and the second prediction probability of the content label are summed and averaged to obtain a prediction probability of the content label;

a theme label full connection layer configured to receive the N-th order feature map output by the N-th order convolutional layer and output a prediction probability of a theme label; and

a category label full connection layer configured to receive the N-th order feature map output by the N-th order convolutional layer and output a prediction probability of a category label,

where 1<n≤N.

In an exemplary embodiment, the network further includes:

a weight full connection layer configured to weight each channel of the N-th order feature map with the prediction probability of the content label before the N-th order feature map is input to the category label full connection layer.

In an exemplary embodiment, the multi-feature-layer merging network is configured to merge layer by layer by merging a higher order feature map with an adjacent lower order feature map.

In an exemplary embodiment, the convolutional network is a GoogleNet network, including five orders of convolutional layers, and the first to fifth orders of feature maps are all input to the multi-feature-layer merging network;

the multi-feature-layer merging network is configured to

cause the fifth order feature map to be subjected to 1×1 convolution and 2-time up-sampling and then, merged with the fourth order feature map to generate the fourth order merged feature map;

cause the fourth order merged feature map to be subjected to 1×1 convolution and 2-time up-sampling and then, merged with the third order feature map to generate the third order merged feature map;

cause the third order merged feature map to be subjected to 1×1 convolution and 2-time up-sampling and then, merged with the second order feature map to generate the second order merged feature map;

cause the second order merged feature map to be subjected to 1×1 convolution and 2-time up-sampling and then, merged with the first order feature map to generate the first order merged feature map; and

output the first order merged feature map to the spatial regularization network.

In an exemplary embodiment, the convolutional network is a Resnet 101 network, including five orders of convolutional layers, and the second to fourth orders of feature maps are all input to the multi-feature-layer merging network;

the multi-feature-layer merging network is configured to

cause the fourth order feature map to be subjected to 1×1 convolution to obtain a convolved fourth order feature map;

cause the convolved fourth order feature map to be subjected to 2-time up-sampling and then, merged with the third order feature map to generate the third order merged feature map;

cause the third order merged feature map to be subjected to 1×1 convolution and 2-time up-sampling, and then merged with the second order feature map to generate the second order merged feature map; and

output the convolved fourth order feature map, the third order merged feature map and the second order merged feature map to the spatial regularization network.

In an exemplary embodiment, the multi-feature-layer merging network further includes:

a first 3×3 convolutional layer configured to convolve the 1×1 convolved fourth order feature map;

a second 3×3 convolutional layer configured to convolve the third order merged feature map; and

a third 3×3 convolutional layer configured to convolve the second order merged feature map,

wherein the multi-feature-layer merging network outputs a 3×3 convolved second order merged feature map, the third order merged feature map, and the fourth order feature map to the spatial regularization network, and the spatial regularization network respectively predicts for the three convolved feature maps and calculates a sum and an average of the prediction results.

A second aspect of the present disclosure provides a training method using the neural network provided in the first aspect of the present disclosure, including:

only training the convolutional network and the category label full connection layer with a category label training data set, to output a prediction probability of a category label, and only saving parameters of the convolutional network;

only training the convolutional network and the second content label full connection layer with a content label training data set, to output a prediction probability of a content label;

keeping the parameters of the convolutional network unchanged, training the multi-feature-layer merging network and the spatial regularization network with the content label training data set, to output the first prediction probability; and

keeping the parameters of the convolutional network unchanged, only training the theme label full connection layer with a theme label training data set to output a prediction probability of a theme label.

In an exemplary embodiment, the network includes a weight full connection layer configured to weight each channel of the N-th order feature map with the prediction probability of the content label before the N-th order feature map is input to the category label full connection layer, and

the training method further includes:

only training the weight full connection layer and the category label full connection layer with the category label training data set.

In an exemplary embodiment, the numbers of training samples of the category label training data set, the content label training data set, and the theme label training data set are different.

In an exemplary embodiment, for the category label training data set, a partial image is randomly cut out from each category label training picture, and the size of the partial image is adjusted to the size of the category label training picture, the partial image and the category label training picture constitute a training sample for the category label;

for the theme label training data set, each theme label training picture is horizontally inverted, and the theme label training picture and the horizontally inverted picture constitute a theme label training sample; and

for the content label training data set, each content label training picture is horizontally inverted, and the content label training picture and the horizontally inverted picture constitute a content label training sample.

A third aspect of the present disclosure provides a method for image multi-label identification, including: inputting a picture of an image into a neural network; receiving a picture of an image and outputting a first order feature map by a first order convolutional layer of the neural network, and receiving the (n−1)-th order feature map output by the (n−1)-th convolutional layer and outputting the n-th order feature map by a n-th order convolutional layer of the neural network; merging feature maps output by at least one high-order convolutional layer and at least one low-order convolutional layer and outputting the merged feature map by a multi-feature-layer merging network of the neural network; receiving the merged feature map by a spatial regularization network of the neural network; receiving a feature map output by the spatial regularization network and outputting a first prediction probability of a content label by a first content label full connection layer of the neural network; receiving an N-th order feature map output by the N-th order convolutional layer and outputting a second prediction probability of the content label by a second content label full connection layer of the neural network, wherein the first prediction probability and the second prediction probability of the content label are summed and averaged to obtain a prediction probability of the content label; receiving the N-th order feature map output by the N-th order convolutional layer and outputting a prediction probability of a theme label by a theme label full connection layer of the neural network; and receiving the N-th order feature map output by the N-th order convolutional layer and outputting a prediction probability of a category label by a category label full connection layer of the neural network, where 1<n≤N.

In an exemplary embodiment, the method further includes randomly selecting a part of the picture of the image and enlarging the part, inputting the picture and the enlarged picture into the neural network trained according to the method of the present disclosure to output a first prediction vector of a category label;

inputting the picture of the image into the neural network to output a second prediction vector of a category label, a prediction vector of a theme label, and a prediction vector of a content label;

summing and averaging the first prediction vector of the category label and the second prediction vector of the category label to obtain an average vector of the category label; and

taking a prediction probability of a category having a highest value resulted from the averaged vectors of the category labels calculated through a softmax function as a prediction probability of the category label of the image, and inputting the prediction vector of the theme label and the prediction vector of the content label into the sigmoid activation function to obtain the prediction probability of the theme label and the prediction probability of the content label.

A fourth aspect of the present disclosure provides a non-transitory computer readable storage medium having stored thereon a computer program, wherein the computer program is implemented by a processor to perform:

the training method according to the second aspect of the present disclosure; or

the identification method according to the third aspect of the present disclosure.

A fifth aspect of the present disclosure provides a computer apparatus including a memory, a processor, and a computer program stored on the memory and operative on the processor, wherein the processor executes the program to:

the training method according to the second aspect of the present disclosure; or

the identification method according to the third aspect of the present disclosure.

### BRIEF DESCRIPTION OF THE DRAWINGS

The specific embodiments of the present disclosure are further described in detail below with reference to the accompanying drawings.

FIG. 1 shows a schematic diagram of a network model of a neural network for image multi-label identification, according to one embodiment of the present disclosure.

FIG. 2 shows a partial schematic diagram of a neural network of the present disclosure exemplified by a GoogleNet network.

FIG. 3 shows a schematic diagram of a multi-feature-layer merging network in the neural network shown in FIG. 2.

FIG. 4 shows a partial schematic diagram of a neural network of the present disclosure exemplified by a ResNet 101 network.

FIG. 5 shows a schematic diagram of a multi-feature-layer merging network in the neural network shown in FIG. 4.

FIG. 6 illustrates an alternative embodiment of the multi-feature-layer merging network of FIG. 5.

FIG. 7 shows a schematic diagram of a network model of a neural network for multi-label identification, according to another embodiment of the present disclosure.

FIG. 8 is a flow chart showing a training method for multi-label identification by a neural network.

FIG. 9 is a schematic block diagram of a computer device according to an embodiment of the present disclosure.

### DETAILED DESCRIPTION

In order to explain the present disclosure more clearly, the present disclosure will be further described in conjunction with preferred embodiments and the accompanying drawings. Similar components in the drawings are denoted by the same reference numerals. It should be understood by those skilled in the art that the following detailed description is intended to be illustrative and not restrictive.

At present, the relevant methods are based on an ordinary photo picture, generating a corresponding content label or a scene label. There is no method for generating a label targeting the characteristics of image (requiring multiple types of labels, including multi-labels and single labels, and ordinary photo picture identification does not require multiple types of labels similar to the images). Also, there is no method for generating a single label and multiple labels simultaneously in the same network.

In addition, the relevant multi-label identification method is based on prediction of top-level features, ignoring the information about features at low levels, which results in poor identification of small targets. Further, due to the spatial relationship between labels being able to help improve the label identification effect, a more accurate target position can be obtained utilizing low-level features, which helps to improve the label identification effect.

Therefore, there is a need to provide a network, a method, and a device that solve the above problems.

### Neural Networks

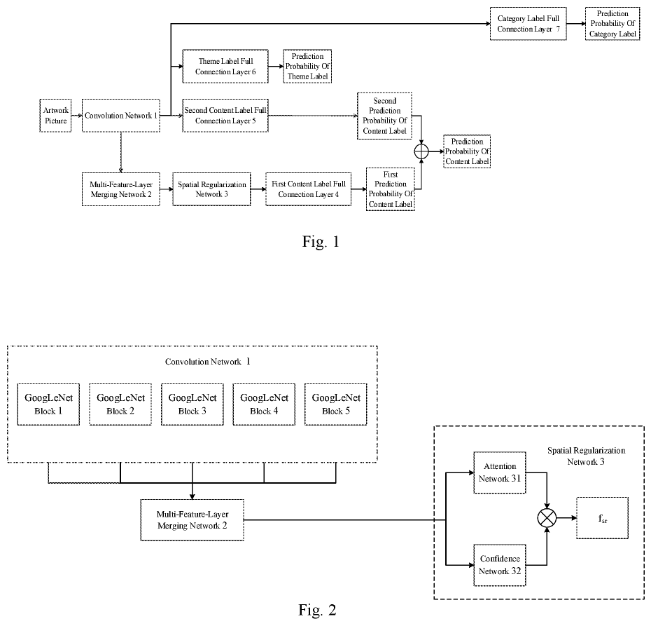

An embodiment of the present disclosure provides a convolutional neural network (CNN) for image multi-label identification, as shown in FIG. 1, including:

a convolutional network 1 including N orders of convolutional layers, wherein the first order convolutional layer receives a picture of an image and outputs a first order feature map, and the n-th order convolutional layer receives the (n−1)-th order feature map output by the (n−1)-th convolutional layer and outputs the n-th order feature map;

a multi-feature-layer merging network 2 configured to merge feature maps output by at least one high-order convolutional layer and at least one low-order convolutional layer, and output the merged feature map;

a spatial regularization network 3 configured to receive the merged feature map;

a first content label full connection layer 4 configured to receive a feature map output by the spatial regularization network 3 and output a first prediction probability of a content label;

a second content label full connection layer 5 configured to receive an N-th order feature map output by the N-th order convolutional layer and output a second prediction probability of the content label, wherein the first prediction probability and the second prediction probability of the content label are summed and averaged to obtain a prediction probability of the content label;

a theme label full connection layer 6 configured to receive the N-th order feature map output by the N-th order convolutional layer and output a prediction probability of a theme label; and

a category label full connection layer 7 configured to receive the N-th order feature map output by the N-th order convolutional layer and output a prediction probability of a category label,

where 1<n≤N.

With the deep network of the embodiment of the present disclosure, multi-label identification for a picture of an image can be realized, and a single label (category label) and a multi-label (content label, theme label) are generated in one network. Moreover, it can improve the identification effect of the content label by merging high and low level features of the content label.

In the field of image identification, there are a large number of neural network models of various types of classified image databases (ImageNet databases) previously trained with 1000 categories, such as GoogleNet, VGG-16, and ResNet 101.

In a specific example of the present disclosure, for example, a picture of an image having a size of 224×224 pixels and 3 channels (such as RGB channels) is input into a convolutional network.

Taking GoogleNet as an example, it includes first to fifth orders of convolutional layers. The feature maps extracted in sequence are: 64 first order feature maps C1 having a size of 112×112, 192 second order feature maps C2 having a size of 56×56, 480 third order feature maps C3 having a size of 28×28, 832 fourth order feature maps C4 having a size of 14×14, and 1024 fifth order feature maps C5 having a size of 7×7.

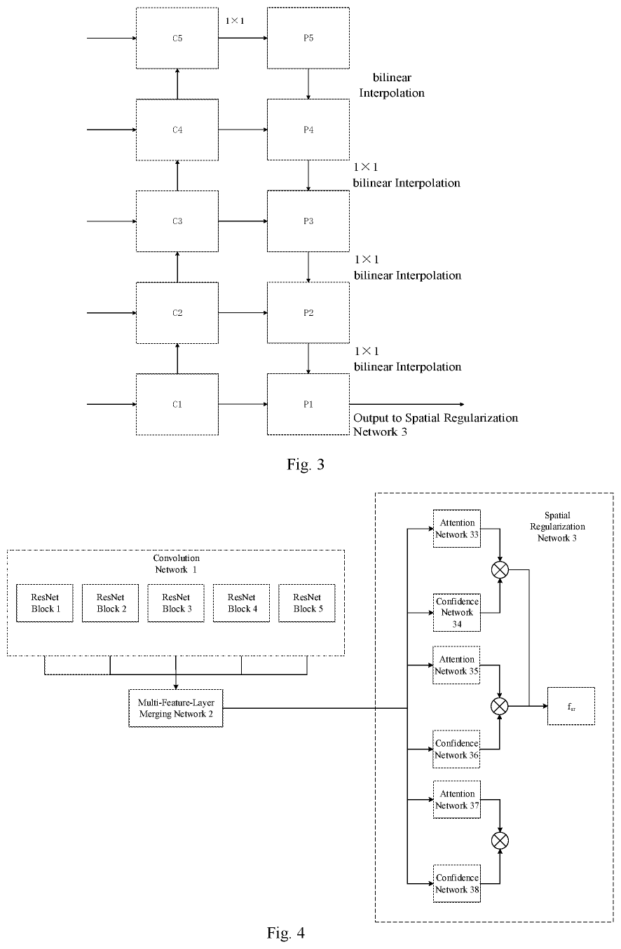

As shown in FIG. 2, the first to fifth order feature maps are all input to the multi-feature-layer merging network 2. FIG. 3 is a merging structure of the multi-feature-layer merging network 2 in the present example.

As shown in FIG. 3, when merging features of multiple sizes, two adjacent orders of features are merged layer by layer progressively. First, features of two sizes at higher orders are merged to a feature of one size, and then, the merged feature map at a higher order is merged with a feature map at a lower order.

When merging two adjacent orders of feature maps, first, the two orders of features are made to a unified dimension. A convolutional layer with a convolution kernel size of 1×1 achieves the dimensionality reduction of the high order feature to reduce the dimension of the higher order feature to the same dimension as the low order feature.

Taking the merging of the 3rd, 4th, and 5th order feature maps as an example, as shown in FIG. 3, the 5th order feature map C5 of a size 7×7×1024 is first converted to P5 of a size 7×7×832 through a convolution kernel of a size 1×1 and, then, converted to a size 14×14×832 by bilinear interpolation. The converted 5th order feature and the 4th order feature are merged and summed pixel by pixel in the corresponding dimension to obtain a merged fourth order feature map P4 having a size of 14×14×832. Similarly, the merged fourth order feature map P4 is converted to a size of 28×28×480 by a convolutional kernel of a size 1×1 and bilinear interpolation and then, summed with the third order feature pixel by pixel in the corresponding dimension to obtain a merged third order feature map P3 having a size of 28×28×480.

With the same operation, a merged second order feature map P2 having a size of 56×56×192, and a merged first order feature map P1 having a size of 112×112×64 are obtained. The merged first order feature map P1 is output to the spatial regularization network 3.

Embodiments of the present disclosure also include an implementation in which a low order feature is converted through a convolutional layer of size 1×1 to increase dimension and then, merged with a high order feature.

Returning to FIG. 2, the merged first order feature map P1 is output to the spatial regularization network 3.

SRN Net is divided into two branches. One branch extracts a feature layer (112×112×64) and obtains an attention graph A through an attention network 31 (3 convolutional layers 1×1×512; 3×3×512; 1×1×C), where C is the total number of labels. The other branch obtains a classification confidence map S through a confidence network 32 and then, calculates a weighted sum of the classification confidence map S and the graph A through a Sigmoid function. The resulted weighted sum is learned by a fₛᵣ network (3 convolutions 1×1×C; 1×1×512, 2048 convolutions having size of 14×14×1 and divided into 512 groups of 4 convolution kernels per group) to obtain a semantic relationship between the labels.

In another specific example of the present disclosure, for example, a picture of an image having a size of 224×224 pixels and 3 channels (such as RGB channels) is input into a convolutional network.

As shown in FIG. 4, in this example, the convolutional network is ResNet 101, including first to fifth orders of convolutional layers and the sizes of the feature maps extracted in sequence are: 128 first order feature maps C1 having a size of 112×112; 256 second order feature maps C2 having a size of 56×56; 512 third order feature maps C3 having a size of 28×28; 1024 fourth order feature maps C4 having a size of 14×14; and 2048 fifth order feature map C5 having a size of 7×7.

Since the low order feature has little semantic information, in the present example, as shown in FIG. 4, only the 2nd to 4th orders of feature maps are input to the multi-feature-layer merging network 2.

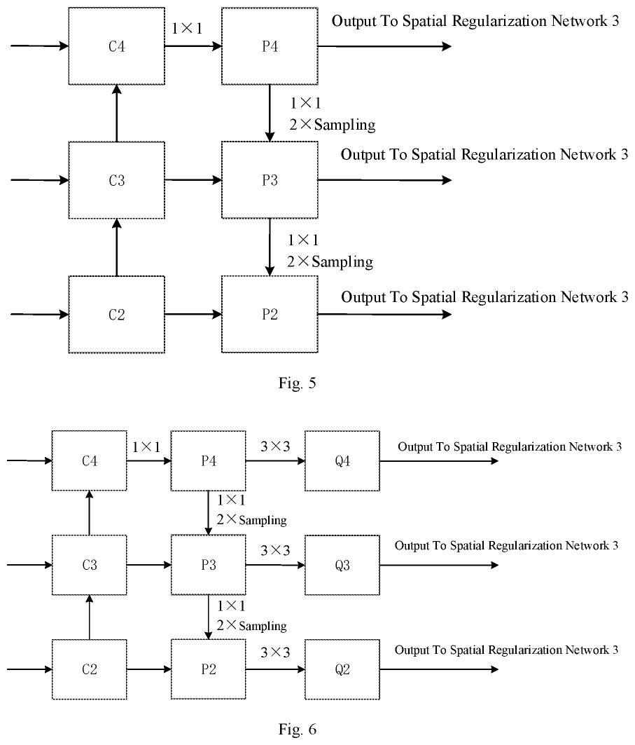

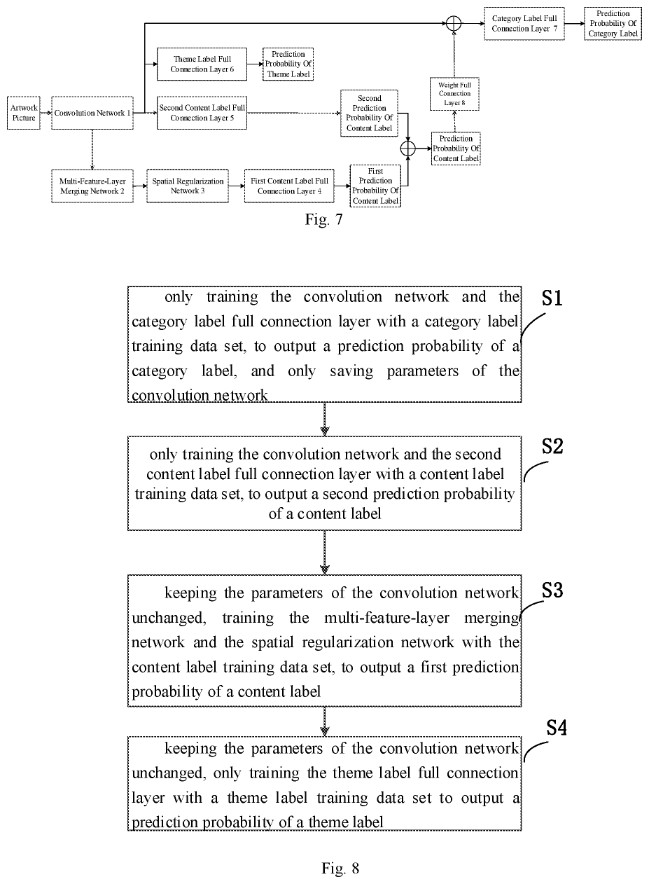

FIG. 5 is a merging structure of the multi-feature-layer merging network 2 in the present example. As shown in the figure, the fourth order feature map C4 has a size of 14×14×1024. The feature map is first converted into P4 having a size of 14×14×512 by a convolutional layer having a convolutional kernel of a size 1×1. Then, the feature map is converted into a size of 28×28×512 by 2-time up-sampling. The converted fourth order feature and the third order feature are merged and summed pixel by pixel in the corresponding dimension to obtain a third order merged feature map P3. Similarly, the merged third order feature map P3 is converted to a size of 56×56×256 by a convolution kernel of a size 1×1 and bilinear interpolation the convolution kernel is a 1×1 convolutional layer and a bilinear interpolation layer and then, summed with the second order feature pixel by pixel in the corresponding dimension to obtain a merged second order feature map P2 having a size of 56×56×256.

Embodiments of the present disclosure also include an implementation in which a low order feature is converted through a convolutional layer of size 1×1 to increase dimension and then, merged with a high order feature.

Compared with the above example of the GoogleNet network, this example outputs the fourth order feature map P4, the third order merged feature map P3, and the second order merged feature map P2 converted by the 1×1 convolutional layer to the spatial regularization network 3.

Turning back to FIG. 4, in this example, the spatial regularization network 3 includes an attention network 33 and a confidence network 34 configured to receive the fourth order feature map P4 converted by the 1×1 convolutional layer; an attention network 35 and a confidence network 36 configured to receive the third order merged feature map P3; and an attention network 37 and a confidence network 38 configured to receive the second order merged feature map P2.

The attention network and the confidence network are independently predicted on the 3 layers, and the obtained prediction results are summed and averaged and then, input into the fₛᵣ network.

In this example, optionally, as shown in FIG. 6, the multi-feature-layer merging network further includes:

a first 3×3 convolutional layer configured to convolve the fourth order feature map convolved by the 1×1 convolutional layer to obtain Q4;

a second 3×3 convolutional layer configured to convolve the third order merged feature map to obtain Q3; and

a third 3×3 convolutional layer configured to convolve the third order merged feature map to obtain Q2,

the multi-feature-layer merging network outputs Q2, Q3, and Q4 to the spatial regularization network 3.

Since the categories of art images are not easy to determine, and the content labels and the category labels have certain semantic relevance, such as bamboo, grapes, shrimp, etc., which often appear in Chinese paintings, while vases, fruits, etc. often appear in oil paintings, the present disclosure utilizes the content labels to enhance and correlate category features.

Specifically, in the embodiment of the present disclosure, the neural network further includes a weight full connection layer 8 configured to weight each channel of the N-th order feature map with the prediction probability of the content label before the N-th order feature map (the fifth order feature map in the example of the Resnet 101 network) is input to the category label full connection layer 7. The weight full connection layer 8 in the example of the Resnet 101 network is a full connection layer of 2048 dimensions. By weighting each channel, it is possible to enhance the category feature with high correlation to the content label. Then, the category label full connection layer 7 is connected to obtain the prediction probability of the category label.

### Training Method

Another embodiment of the present disclosure provides a training method for performing multi-label identification by using the neural network in the above embodiment. As shown in FIG. 8, the method includes the following steps.

In S1, only the convolutional network and the category label full connection layer are trained with a category label training data set, to output a prediction probability of a category label, and only parameters of the convolutional network are saved.

Still using the example of the Resnet 101 network, specifically, only the blocks 1-4 (block 1-block 4), block 5 (block 5), and the category label full connection layer 7 of the backbone network Resnet 101 in FIG. 1 are trained. The output is a predicted category label ŷ_{class}, loss₁=loss_{class}, where the category label loss function loss_{class} is calculated according to the softmax cross entropy loss method. Then, only the network parameters of the backbone network Resnet 101 block 1-block 4 and block 5 are saved.

In S2, only the convolutional network and the second content label full connection layer are trained with a content label training data set to output a prediction probability of a content label.

Specifically, only the backbone network Resnet 101 block 1-block 4, block 5, and the second content label full connection layer 5 in FIG. 1 are trained, and the output is the predicted content label ŷ_{content_1}. loss₂=loss_{content_1}, where the content label loss function loss_{content_1} is calculated according to the sigmoid cross entropy loss method.

In S3, the parameters of the convolutional network are kept unchanged, and the multi-feature-layer merging network and the spatial regularization network are trained with the content label training data set to output a first prediction probability of a content label.

Specifically, the Resnet backbone network parameters are fixed, and the lower networks (i.e. the multi-feature-layer merging network 2 and the spatial regularization network 3) in FIG. 1 are trained with the content label training data set. The training process is similar to the training process of the attention network and the spatial regularization network in the existing SRN network, and the first prediction probability ŷ_{content_2} of the corresponding content label is obtained, where loss₃=loss_{content_2}, calculated according to sigmoid cross entropy loss method.

The predicted probability ŷ_{content} of the final content label is obtained by averaging the corresponding result ŷ_{content_1} in S2 and the corresponding result ŷ_{content_2}.

In S4, the parameters of the convolutional network are kept unchanged, and only the theme label full connection layer is trained with a theme label training data set to output a prediction probability of a theme label.

Specifically, the Resnet backbone network parameters are fixed, only the theme label full connection layer 6 in FIG. 1 is trained, and the output is the prediction probability ŷₜₕₑₘₑ of the theme label. loss₄=lossₜₕₑₘₑ, where the theme label loss function lossₜₕₑₘₑ is calculated according to sigmoid cross entropy loss method.

The non-holistic training method adopted by the present disclosure is a step-by-step training method, and the training of the present disclosure can speed up convergence and improve accuracy compared to the holistic training method.

When the neural network of the present disclosure includes the weight full connection layer 8, the training method further includes only training the weight full connection layer 8 and the category label full connection layer 7 with the category label training data set.

Specifically, all the above network parameters are fixed, and only the weight full connection layer 8 and the category label full connection layer 7 are trained with the category label training data set, thereby improving the identification effect of the category label, loss₅=loss_{class}, and category label loss function is calculated according to softmax cross entropy loss method.

When the neural network of the present disclosure includes the weight full connection layer 8, in step S1, the values of the weight full connection layer 8 have to be set to 1, that is, weights are not provided.

In addition, since some categories of images have more content labels (such as oil paintings) and some categories have fewer content labels (such as sketches), if a model uses the same dataset to train categories, themes, and content labels, it is difficult to ensure that the training samples are balanced. Therefore, a step-by-step training method with a separate dataset is adopted, and the dataset is divided into three datasets: category, theme, and content. The number of training samples in the three datasets can be different from each other, as long as the numbers of each kind of samples in each dataset are balanced. Therefore, the amount of data annotation can be reduced.

Compared with the existing photo label identification, the category label identification of images has the problem of being difficult to distinguish image categories, such as oil painting and gouache, realistic oil paintings, and photographic works. If only the captured, low-resolution images are used, it is difficult to distinguish the texture of pigment, strokes, materials, etc. In order to distinguish categories, not only the characteristics of the entire image, but also the partially enlarged texture image are needed for distinguishing.

Therefore, an embodiment of the present disclosure provides a method for expanding training data sets of different labels, specifically as follows.

For the category label training data set, a partial image is randomly cut out from each category label training picture, and the size of the partial image is adjusted to the size of the category label training picture. The partial image and the category label training picture constitute the category label training sample.

For example, for confusing pictures, such as oil paintings, gouaches, watercolors, and photography, it is necessary to distinguish by texture. Therefore, a local texture image is added, and 4 pieces are randomly cut out from each training picture with a cutting ratio of 50%-70% of the original picture. Then, the picture cut out is adjusted to the original size, which is equivalent to a partially enlarged picture. The enlarged pictures and the original pictures total 5 pictures, and they are taken as the training sample.

For the theme label training data set, each theme label training picture is horizontally inverted, and the theme label training picture and the inverted picture constitute a theme label training sample.

For the content label training data set, each content label training picture is horizontally inverted, and the content label training picture and the horizontally inverted picture constitute a content label training sample.

For example, the training of themes and content labels is not suitable for partially cut images, because it will destroy integrity of its content, so only the original picture and the horizontally inverted picture are used for data expansion.

### Image Multi-Label Identification Method

Another embodiment of the present disclosure provides a method for multi-label identification with a neural network, including:

inputting a picture of an image into a neural network trained according to the method of the present disclosure to output a prediction probability of a content label, a prediction probability of a theme label, and a prediction probability of a category label.

In a specific embodiment of the present disclosure, the identifying method further includes:

randomly selecting a part of the picture of the image and enlarging the part, and inputting the picture of the image and the enlarged picture into the neural network trained according to the method of the present disclosure to output a first prediction vector of a category label;

inputting the picture of the image into the neural network to output a second prediction vector of a category label, a prediction vector of a theme label, and a prediction vector of a content label;

summing and averaging the first prediction vector of the category label and the second prediction vector of the category label to obtain an average vector of the category label; and

taking a prediction probability of a category having a highest value resulting from the averaged vectors of the category labels calculated through a softmax function as a prediction probability of the category label of the image, inputting the prediction vector of the theme label and the prediction vector of the content label into the sigmoid activation function to obtain the prediction probability of the theme label and the prediction probability of the content label.

### Computer Readable Medium and Electronic Device

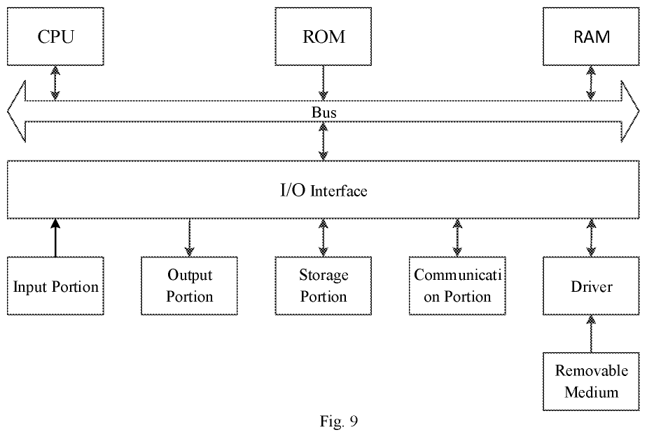

As shown in FIG. 9, a computer device suitable for implementing the above training method, test method, data set expanding method, and identification method includes a central processing unit (CPU) which can perform various appropriate actions and processes in accordance with a program stored in a read only memory (ROM) or a program loaded from a storage portion into a random access memory (RAM) In the RAM, various programs and data required for the operation of the computer system are also stored. The CPU, the ROM, and the RAM are connected through a bus. An input/input (I/O) interface is also connected to the bus.

The following components are connected to the I/O interface: an input portion including a keyboard, a mouse, etc.; an output portion including a liquid crystal display (LCD) or the like, a speaker, or the like; a storage portion including a hard disk or the like; and a communication portion including a network interface card such as a LAN card, a modem, or the like. The communication portion performs communication processing via a network, such as the Internet. The driver is also connected to the I/O interface as needed. A removable medium, such as a magnetic disk, an optical disk, a magneto-optical disk, a semiconductor memory or the like, is mounted on the driver as needed so that a computer program read therefrom is installed into the storage portion as needed.

In particular, according to the present embodiment, the process described in the above flowchart can be implemented as a computer software program. For example, the present embodiment includes a computer program product including a computer program tangibly embodied on a non-transitory computer readable medium, the computer program including program codes for executing the method illustrated in the flowchart. In such an embodiment, the computer program can be downloaded and installed from the network via a communication portion, and/or installed from a removable medium.

The flowcharts and schematic diagrams in the Figures illustrate the architecture, functionality, and operation of possible implementations of the systems, methods, and computer program products of the present embodiments. In this regard, each block in the flowchart or diagram may represent a module, a program segment, or a portion of codes that includes one or more of executable instructions configured to implement the specified logic functions. It should also be noted that in some alternative implementations, the functions noted in the blocks may also be performed in a different order than that illustrated in the drawings. For example, two successively represented blocks may in fact be executed substantially in parallel, and they may sometimes be executed in the reverse order, depending upon the functionality involved. It is also noted that each block of the schematic diagrams and/or flowcharts, as well as combinations of blocks in the schematic diagrams and/or flowcharts, can be implemented in a dedicated hardware-based system that performs the specified functions or operations. Alternatively, it can be implemented by a combination of dedicated hardware and computer instructions.

The units described in this embodiment may be implemented by software or by hardware. The described unit may also be provided in a processor, for example, as a processor, including a convolutional network unit, a multi-feature-layer merging network element, and the like.

In another aspect, the embodiment further provides a non-volatile computer storage medium, which may be a non-volatile computer storage medium included in the device in the above embodiment. It may be a non-volatile computer storage medium that exists alone and is not assembled into the terminal. The above non-volatile computer storage medium stores one or more programs that, when executed by one device, cause the device to implement the above-described training method or identification method.

It should be noted that in the description of the present disclosure, relational terms, such as first and second, etc., are only used to distinguish one entity or operation from another entity or operation and do not necessarily require or imply that there is any such actual relationship or order between these entities and operations. Furthermore, the term “including” or “comprising” or any other variations thereof is intended to encompass a non-exclusive inclusion, such that a process, a method, an article, or a device that includes a plurality of elements includes not only those elements but also other elements, or elements that are inherent to such a process, a method, an article, or a device. An element that is defined by the phrase “including a . . . ” does not exclude the presence of additional equivalent elements in the process, the method, the article, or the device that includes the element.

It is apparent that the above-described embodiments of the present disclosure are merely illustrative of the present disclosure and are not intended to limit the embodiments of the present disclosure. For those skilled in the art, deviations from the above description may also be made. It is to be understood that various changes and modifications may be made without departing from the spirit and scope of the present disclosure.

What is claimed is:

1. A neural network for image multi-label identification, comprising:
a convolutional network comprising N orders of convolutional layers, wherein the first order convolutional layer receives a picture of an image and outputs a first order feature map, and the n-th order convolutional layer receives an (n−1)-th order feature map output by an (n−1)-th convolutional layer and outputs an n-th order feature map;
a multi-feature-layer merging network configured to merge feature maps output by at least one high-order convolutional layer and at least one low-order convolutional layer and output a merged feature map;
a spatial regularization network configured to receive the merged feature map;
a first content label full connection layer configured to receive the feature map output by the spatial regularization network and output a first prediction probability of a content label;
a second content label full connection layer configured to receive an N-th order feature map output by the N-th order convolutional layer and output a second prediction probability of the content label, wherein the first prediction probability and the second prediction probability of the content label are summed and averaged to obtain a prediction probability of the content label;
a theme label full connection layer configured to receive the N-th order feature map output by the N-th order convolutional layer and output a prediction probability of a theme label; and
a category label full connection layer configured to receive the N-th order feature map output by the N-th order convolutional layer and output a prediction probability of a category label, where 1<n≤N.

2. The neural network for image multi-label identification according to claim 1, further comprising:
a weight full connection layer configured to weight each channel of the N-th order feature map with the prediction probability of the content label before the N-th order feature map is input to the category label full connection layer.

3. The neural network for image multi-label identification according to claim 1, wherein the multi-feature-layer merging network is configured to merge layer by layer by merging a higher order feature map with an adjacent lower order feature map.

4. The neural network for image multi-label identification according to claim 2, wherein the multi-feature-layer merging network is configured to merge layer by layer by merging a higher order feature map with an adjacent lower order feature map.

5. The neural network for image multi-label identification according to claim 3, wherein:
the convolutional network is a GoogleNet network, comprising the five orders of convolutional layers, and the first to fifth orders of feature maps are all input to the multi-feature-layer merging network;
the multi-feature-layer merging network is configured to:
cause the fifth order feature map to be subjected to 1×1 convolution and 2-time up-sampling, and then merged with the fourth order feature map to generate the fourth order merged feature map;
cause the fourth order merged feature map to be subjected to 1×1 convolution and 2-time up-sampling, and then merged with the third order feature map to generate the third order merged feature map;
cause the third order merged feature map to be subjected to 1×1 convolution and 2-time up-sampling, and then merged with the second order feature map to generate the second order merged feature map;
cause the second order merged feature map to be subjected to 1×1 convolution and 2-time up-sampling, and then merged with the first order feature map to generate the first order merged feature map; and
output the first order merged feature map to the spatial regularization network.

6. The neural network for image multi-label identification according to claim 3, wherein:
the convolutional network is a Resnet 101 network, comprising the five orders of convolutional layers, and the second to fourth orders of feature maps are all input to the multi-feature-layer merging network;
the multi-feature-layer merging network is configured to:
cause the fourth order feature map to be subjected to a 1×1 convolution to obtain a 1×1 convolved fourth order feature map;
cause the convolved fourth order feature map be subjected to a 2-time up-sampling, and then merged with the third order feature map to generate a third order merged feature map;
cause the third order merged feature map to be subjected to the 1×1 convolution and the 2-time up-sampling, and then merged with the second order feature map to generate a second order merged feature map; and
output the 1×1 convolved fourth order feature map, the third order merged feature map and the second order merged feature map to the spatial regularization network.

7. The neural network for image multi-label identification according to claim 6, wherein the multi-feature-layer merging network further comprises:
a first 3×3 convolutional layer configured to convolve the 1×1 convolved fourth order feature map;
a second 3×3 convolutional layer configured to convolve the third order merged feature map; and
a third 3×3 convolutional layer configured to convolve the second order merged feature map,
wherein the multi-feature-layer merging network outputs a 3×3 convolved second order merged feature map, the third order merged feature map, and the 1×1 convolved fourth order feature map to the spatial regularization network, and the spatial regularization network respectively predicts for the three convolved feature maps and calculates a sum and an average of the prediction results.

8. A training method using a neural network for image multi-label identification, the neural network comprising:
a convolutional network comprising N orders of convolutional layers, wherein the first order convolutional layer receives a picture of an image and outputs a first order feature map, and the n-th order convolutional layer receives an (n−1)-th order feature map output by an (n−1)-th convolutional layer and outputs an n-th order feature map; a multi-feature-layer merging network configured to merge feature map output by at least one high-order convolutional layer and at least one low-order convolutional layer and output a merged feature map; a spatial regularization network configured to receive the merged feature map; a first content label full connection layer configured to receive the feature map output by the spatial regularization network and output a first prediction probability of a content label; a second content label full connection layer configured to receive an N-th order feature map output by the N-th order convolutional layer and output a second prediction probability of the content label, wherein the first prediction probability and the second prediction probability of the content label are summed and averaged to obtain a prediction probability of the content label; a theme label full connection layer configured to receive the N-th order feature map output by the N-th order convolutional layer and output the prediction probability of a theme label; and a category label full connection layer configured to receive the N-th order feature map output by the N-th order convolutional layer and output the prediction probability of a category label, where 1<n≤N,
only training the convolutional network and the category label full connection layer with a category label training data set, to output the prediction probability of the category label, and only saving parameters of the convolutional network;
only training the convolutional network and the second content label full connection layer with a content label training data set, to output the prediction probability of the content label;
keeping the parameters of the convolutional network unchanged, training the multi-feature-layer merging network and the spatial regularization network with the content label training data set, to output the first prediction probability of the content label; and
keeping the parameters of the convolutional network unchanged, only training the theme label full connection layer with a theme label training data set to output the prediction probability of the theme label.

9. The training method according to claim 8, wherein:
the convolutional network comprises a weight full connection layer configured to weight each channel of the N-th order feature map with the prediction probability of the content label before the N-th order feature map is input to the category label full connection layer, and
the training method further comprises:
only training the weight full connection layer and the category label full connection layer with the category label training data set.

10. The training method according to claim 8, wherein numbers of training samples of the category label training data set, the content label training data set, and the theme label training data set are different.

11. The training method according to claim 9, wherein numbers of training samples of the category label training data set, the content label training data set, and the theme label training data set are different.

12. The training method according to claim 8, wherein:
for the category label training data set, a partial image is randomly cut out from each category label training picture, and size of the partial image is adjusted to the size of the category label training picture, the partial image and the category label training picture constitute a training sample for the category label;
for the theme label training data set, each theme label training picture is horizontally inverted, and the theme label training picture and a horizontally inverted picture constitute a theme label training sample; and
for the content label training data set, each content label training picture is horizontally inverted, and the content label training picture and the horizontally inverted picture constitute a content label training sample.

13. The training method according to claim 9, wherein
for the category label training data set, a partial image is randomly cut out from each category label training picture, and size of the partial image is adjusted to the size of the category label training picture, the partial image and the category label training picture constitute a training sample for the category label;
for the theme label training data set, each theme label training picture is horizontally inverted, and the theme label training picture and a horizontally inverted picture constitute a theme label training sample; and
for the content label training data set, each content label training picture is horizontally inverted, and the content label training picture and the horizontally inverted picture constitute a content label training sample.

14. A method for image multi-label identification, comprising:
inputting a picture of an image into a neural network;
receiving the picture of the image and outputting a first order feature map by a first order convolutional layer of the neural network, and receiving an (n−1)-th order feature map outputting by an (n−1)-th convolutional layer and outputs an n-th order feature map by an n-th order convolutional layer of the neural network;
merging feature map output by at least one high-order convolutional layer and at least one low-order convolutional layer and outputting a merged feature map by a multi-feature-layer merging network of the neural network;
receiving the merged feature map by a spatial regularization network of the neural network;
receiving the feature map output by the spatial regularization network and outputting a first prediction probability of a content label by a first content label full connection layer of the neural network;
receiving an N-th order feature map output by an N-th order convolutional layer and output a second prediction probability of the content label by a second content label full connection layer of the neural network, wherein the first prediction probability and the second prediction probability of the content label are summed and averaged to obtain a prediction probability of the content label;
receiving the N-th order feature map output by the N-th order convolutional layer and output the prediction probability of a theme label by a theme label full connection layer of the neural network; and
receiving the N-th order feature map output by the N-th order convolutional layer and outputting the prediction probability of a category label by a category label full connection layer of the neural network, where 1<n≤N.

15. The method for image multi-label identification according to claim 14, further comprising:
weighting each channel of an N-th order feature map with the prediction probability of the content label by a weight full connection layer of the neural network before the N-th order feature map is input to the category label full connection layer.

16. The method for image multi-label identification according to claim 14, wherein the multi-feature-layer merging network is configured to merge layer by layer by merging a higher order feature map with an adjacent lower order feature map.

17. The method for image multi-label identification according to claim 14, further comprising:
randomly selecting a part of the picture of the image and enlarging the part, inputting the picture and an enlarged picture into the neural network trained according to the method of the present disclosure, to output a first prediction vector of the category label;
inputting the picture of the image into the neural network, to output a second prediction vector of the category label, a prediction vector of the theme label and a prediction vector of the content label;
summing and averaging the first prediction vector of the category label and the second prediction vector of the category label to obtain an average vector of the category label; and
taking the prediction probability of a category having a highest value resulted from the averaged vectors of the category labels calculated through a softmax function as the prediction probability of the category label of the image, inputting the prediction vector of the theme label and the prediction vector of the content label into a sigmoid activation function, to obtain the prediction probability of the theme label and the prediction probability of the content label.

18. A computer readable storage medium having stored thereon a computer program, wherein the program is implemented by a processor to perform:
the identification method according to claim 14.

19. A computer readable storage medium having stored thereon a computer program, wherein the program is implemented by a processor to perform:
the identification method according to claim 15.

20. A computer apparatus comprising a memory, a processor, and a computer program stored on the memory and operative on the processor, wherein the processor executes the program to implement: the identification method according to claim 14.
